(19) United States
(12) Patent Application Publication
(10) Pub. No.: US 2023/0049657 A1
(43) Pub. Date: Feb. 16, 2023

(54) ELECTRONIC SPORTS BETTING SYSTEM AND METHOD

(71) Applicant: EBET, INC., Las Vegas, NV (US)

(72) Inventors: Jonathan Pearce, Lancaster, PA (US); Bradley Cole, Las Vegas, NV (US)

(21) Appl. No.: 17/889,314

(22) Filed: Aug. 16, 2022

Related U.S. Application Data
(60) Provisional application No. 63/233,518, filed on Aug. 16, 2021.

(51) Int. Cl. G07F 17/32; G06Q 50/34; H04N 21/2187; H04N 21/234

(52) U.S. Cl. CPC G07F 17/323; G07F 17/3276; G07F 17/3288; G06Q 50/34; H04N 21/2187; H04N 21/23418

(57) ABSTRACT

An electronic sports betting system and method includes a betting extension in a browser of a client computer, communicating with an odds modeling engine of a betting platform. The betting platform defines a tournament structure of an electronic sports tournament comprising teams performing the electronic sports tournament on a computer network, and generates a module for each of a number of distinct parts of the tournament structure. The betting platform successively simulates each module to generate a model for the electronic sports tournament, the model representing possible actions and outcomes by the teams performing each of a number of distinct parts of the tournament structure. The betting platform then models team behavior of each of the teams based on the model, and generates odds of the possible actions and outcomes of the electronic sports tournament based on the successive simulation of each module.

### CROSS-REFERENCES TO RELATED APPLICATIONS

The present application claims priority of U.S. Provisional Application No. 63/233,518, filed Aug. 16, 2021, and entitled “ELECTRONIC SPORTS BETTING SYSTEM AND METHOD”, the entirety of which is incorporated by reference herein.

### TECHNICAL FIELD

The subject matter described herein relates to electronic sports, and more particularly to an electronic sports betting system and method, for simulating and modeling tournaments of different types of electronic sports in order to provide real-time betting odds for electronic sports such as multi-player video games and the like.

### BACKGROUND

Sports betting is a form of gambling that involves predicting results of a sport activity or game, and placing a bet or wager on the outcome of that activity or game. For instance, bettors can place a bet as to which of two competing teams will prevail in a match or game, such as a soccer match or football game. In some cases, sports betting can occur at a more granular level, such as betting on the outcome of a single action, such as a single play of a football game, or whether a score of a soccer match will change over a short term of minutes. Sports betting can occur legally, such as through an official bookmaker, or illegally through private groups or entities. Betting on sport events and other competitions has occurred for as long as there has been competition.

More recently, however, there has been a rising popularity of so-called electronic sports, otherwise known as “esports,” in which competition or activities occur in the context of a video game or online streaming digital media, and is observed and followed by fans solely through that domain or venue, referred to herein as a “streaming platform.” Esports are typically conducted as a multiplayer video game, where players can be individual players or a collection of players in a team.

Early participants in esports were usually amateur players, and spectators were typically limited to the players themselves or friends in close proximity to a player's computer or gaming display. However, with the growing use of real-time, browser-based streaming platforms such as YouTube® or Twitch®, which are particularly suited for real-time streaming of multiplayer video game content, spectatorship of esports games and activities has grown exponentially, and players are often professional and monetarily compensated.

Several websites for esports betting have been introduced, such as Gogawi.com by Esports Technologies Inc. These websites, while featuring rich content and information about a corresponding esports event to allow a fan to place bets on the event, are still separate and apart from the main streaming platform used by the esports event to stream the event. Accordingly, the betting experience through such websites requires a user to divert their attention from the streaming platform to such website to place a bet or monitor their outcomes, and includes many extra steps, such as login, customer authentication, etc., that are in addition to the primary viewing experience of the streaming media of the esports event. Thus, a favorable live betting experience with esports is elusive.

Need the ability to simulate tournaments of differing types including chaining them together. We need to be able to price teams placing in any position, teams to make/not make playoffs, number games won by a particular team, highest finish of teams in a list, etc. Because esports tournaments are complicated we need the ability to specify best of X by stage.

### SUMMARY

The system and method disclosed herein provide the ability to simulate tournaments of differing types, and to develop an odds model for use in a betting algorithm. In some implementations, a system and method are configured to chain together different types of tournaments and electronic sports. The system and method allow teams placing in any position to be priced, teams to make/not make playoffs, number games won by a particular team, highest finish of teams in a list, etc. In some implementations, due to the complexity and multidimensional nature of esports tournaments, the system and method can be configured to specify a “best of X” by any stage or dimension of a simulated tournament.

In some aspects, a system, method, and computer program product are provided, and which are used or executed to define a tournament structure of an electronic sports tournament. The tournament structure includes two or more teams performing the electronic sports tournament on a computer network, each of the plurality of teams including one or more players using a computer connected to the computer network. The system, method, and computer program product are further configured to generate a module for each of a plurality of distinct parts of the tournament structure, and successively simulate each module to generate a model for the electronic sports tournament. The model represents possible actions and outcomes by the teams performing each of the plurality of distinct parts of the tournament structure. The system, method and computer program product are further configured to model team behavior of each of the plurality of teams based on the model, and generate odds of the possible actions and outcomes of the electronic sports tournament based on the successive simulation of each module.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an electronic sports betting system and method, it should be readily understood that such features are not intended to be limiting. For instance, the currently disclosed subject matter of odds modeling for applications performed on a computing system other than esports, such as financial transactions, trading, online sales, or the like. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter; and

FIG. 2 shows a flowchart of an odds modeling method performed by a system consistent with implementations of the current subject matter.

When practical, similar reference numbers denote similar structures, features, or elements.

### DETAILED DESCRIPTION

This document describes a system and method that provide the ability to simulate tournaments of differing types, and to develop an odds model for use in a betting algorithm. In some implementations, the system and method are configured to chain together different types of tournaments and esports. The system and method allow teams placing in any position to be priced in the odds model, teams to make/not make playoffs, number of games won by a particular team, highest finish of teams in a list, etc. In some implementations, due to the complexity and multidimensional nature of esports tournaments, the system and method can be configured to specify a “best of X” by any stage or dimension of a simulated tournament, and also included in the odds modeling algorithm that generates the odds model.

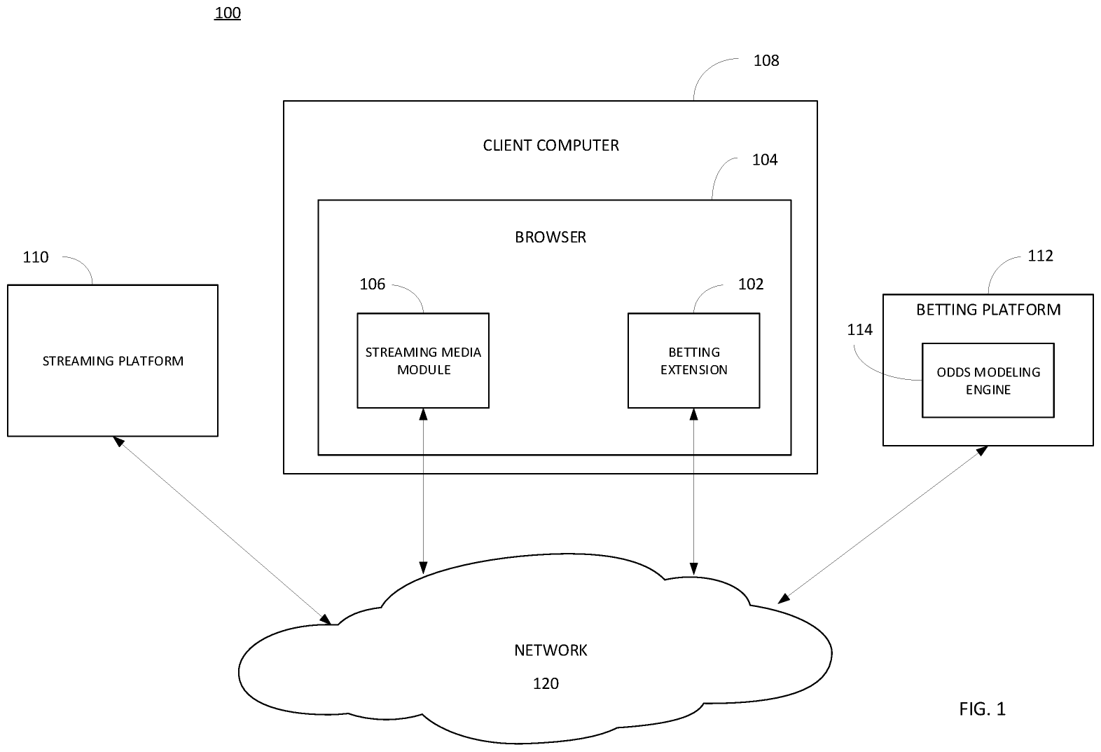

FIG. 1 is a block diagram illustrating an exemplary implementation of a system 100 that includes a betting extension 102, which can be an extension of a browser 104 that hosts or executes a streaming media module 106. The browser 104 is in turn executed on a client computer 108 and displayed in a graphical user interface provided by the client computer 108. The streaming media module 106 can stream video of an esports event or tournament (i.e. a collection of events, some of which can be streamed simultaneously), received from a streaming platform 110 via network 120.

The betting extension 102 can by synchronized with the video stream, to seamlessly allow a viewer or user to place a bet, or provide other input, on the outcome of an activity of the esports event. In some implementations, the betting extension 102 provides a common user interface (UI)/user experience (UX) regardless of browser 104 or streaming media modul 106 running on the client computer 108. The betting extension 102 can leverage user logon credentials or other account sign-in information used with other services provided by the betting platform 112, which can reduce costs and streamlines the user experience. The betting extension 102 can also be integrated with messaging applications hosted or used by the client computer 108, to integrate betting notifications, alerts or confirmations.

The network 120 can be the Internet, and can include any number of wireless or wired communication mediums that communicate the streaming media from the streaming platform 110 to the streaming media module 106 hosted by the browser 104 on the client computer 108.

The bet or other input is processed by a betting platform 112, which also communicates with the betting extension 102 via the network 120. Each of the streaming platform 110 and the betting platform 112 can be a server computer, a server component running on a server, or a collection of servers in a common facility or distributed among a number of facilities. In some implementations, the streaming platform 110 and the betting platform can be integrated in or hosted by the same server, or distributed among multiple servers.

The betting platform 112 includes an odds modeling engine 114, which is implemented by one or more processors, for generating one or more models of betting odds for esports events and tournaments, as discussed herein.

In some implementations, exemplified herein with reference to an esports game called LoL Words™, odds modeling and betting execution can be performed as follows. While the example provides for ten teams, those of skill in the art would appreciate that the technology described herein can be applied to any number of teams:

PLAY-IN ROUND 1

Ten teams are divided into two groups where they play a Single Round Robin format.
All matches are played in a Bo1.
Top teams in each group advance to Group Stage.
2nd, 3rd and 4th teams in each group advance to Play-In: Round 2.
Bottom team in each group is eliminated.
Tiebreaker Rules

If teams are tied and competing for 3rd and 4th place, there will not be any additional matches, the placement will be determined by their head-to-head result.

In other circumstances:
If there are two teams have an equal amount or number of points, an additional tiebreaker match will be played
Team that won the head-to-head result will have the side choice privilege.

If there are three teams have an equal amount or number of points, two circumstances will be considered:
If all three teams have the same results against the other two teams, two teams that won with longer time length will compete first. The loser will be the bottom team in this tie, the winner will compete with the remained team.
   Team that won with shorter time length will have the side choice privilege.
   If the remained two teams are competing for 3rd and 4th place, the placement will be determined by their head-to-head result.
If three team has different results against the other two teams, the tie will be broken by the results (2-0, 1-1 and 0-2).

If there are five teams have an equal amount or number of points,
All the teams will be ranked by the total time length of winning games, the two teams won with the longest total time length will compete first, loser will be placed fifth, winner will play a single elimination bracket with the other three teams.
In the single elimination bracket, the team that won with shortest time length will face the team won with the longest time length, the other two will compete, two winners will compete for 1st place.
   3rd and 4th place match will not be played.
All tiebreaker matches are Bo1

PLAY-IN ROUND 2
Six teams from Play-In: Round 1.
The 3rd and 4th placed teams of the same group of Round 1 face each other, winners compete against the 2nd placed team of the other group
All matches are played in a Bo5.
Two winners will advance to Group Stage.
Four losers will be eliminated

GROUP STAGE

Four teams from the Play-In Stage join twelve teams with direct entry from China, South Korea, Europe, North America and Southeast Asia.
All sixteen teams are divided into four groups where they play a Double Round Robin format.
All matches are played in a Bo1.
Top two teams in each group advance to Playoffs.
Bottom two teams in each group are eliminated.

PLAYOFFS
Eight teams play in a single elimination bracket where 1st placed team of each group faces 2nd placed team from another group.
Side Selection Privilege
   Teams with Side Selection Privilege can choose the side in game 1, after that, the team lost can choose the side in the next game.
   In Quarterfinals, 1st placed team from each group will have the Side Choice Privilege.
   In the following matches, the Side Choice Privilege will be determined by coin flip.
All matches are Bo5.

As described above, the esports tournament includes a round robin with possible tiebreaker matches, a bracket with byes, a double round robin, and a bracket where seeding is an advantage. In other implementations, an esports tournament can include one or more of the following: single elimination (possible byes, possible reseeding); double elimination (possible byes, possible reseeding); round robin; double round robin; Swiss; N-(Win/Loss) Swiss; top 5/6 format; regular season with defined schedule; battle royale events; and others. Each of these formats and implementations are so complex and multidimensional, such that computer simulation by the odds modeling engine 114 is the only way to generate proper or accurate odds on a winner at each stage and on other wagers.

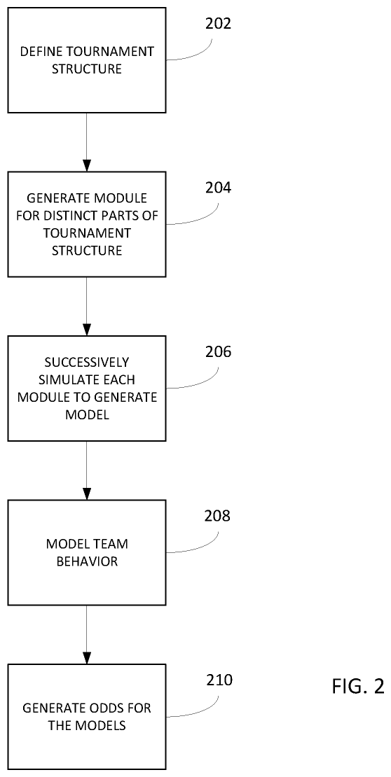

A flowchart of an odds modeling method is shown in FIG. 2. At 202, a computing system defines a tournament structure for an esports tournament. The tournament structure can be defined in response to user input or user selection from a menu generated by the computing system and displayed to the user. Or, the tournament structure can be defined automatically using an artificial intelligence (AI) algorithm based on historical data, similar tournament information, tournament participants, or other aspects. At 204, the computing system generates a module for each of a number of distinct parts of the tournament structure. These distinct parts can be rounds of play, matches, or other parts of the tournament. At 206, the computing system successively simulates each module to generate a model. The model can represent odds of occurrences within each of the distinct parts of the tournament structure, and can represent either selective parts or an aggregate of the entire tournament structure.

At 208, the computing system executes a program to model team behavior for each team that will participate in the tournament, and according to the tournament structure, and which can be for each of the distinct parts of the tournament structure. At 210, the computing system executes an odds modeling module to generate odds for each of the models, based on the modeled team behavior. The computing system can transmit these generated odds to any end user, preferably via an electronic communication network to a remote client computer, such as a mobile computing device, laptop computer, desktop computer, or the like.

Some of these formats may be decomposed to other types. The goal is to make these modular so a tournament structure can be defined, and one module fed into the next. In the example of LoL Worlds, a round robin module is defined that will give us the probability of each team placing 1^{st}-5^{th}. The results of that can feed into a seeded bracket module giving each team's chances of winning 0,1,2 games and advancing. This would continue until the entire event is simulated. The result of the odds modeling is the ability to offer live prices on nearly all markets as live win probabilities update.

The individual games need not be modeled. However, when needed, team behavior will need to be modeled: i.e., teams choosing their opponents, teams attempting to get a particular seed, etc. Win probabilities will be provided by the underlying model and where needed stats for tiebreakers (maps, times, etc.). Some point estimates of the win probability for teams will need perturbation or to be drawn from a distribution to add variation. For live pricing, the probability of a game may update rapidly thus one or more of the following will be needed: rapid computation (every second that the model spends computing is a second the betting platform 112 cannot take live wagers and make money) of the whole event after an update, an indication that the change in a live probability is too small to warrant a new computation, implementing efficient storage of the conditional probabilities of all teams given wins/losses in the live matches and perform quick calculations on the conditional probabilities.

In some implementations, this works as a build-a-bet option. Customers should be able to pick any place for any team, specify a team to beat other teams at other points in the event, etc. These are correlated parlays so the system is unable to simply multiply the individual probabilities. These custom selections should evaluate quickly (either a fast function or lookup table) so the customer sees the odds update after they modify their ticket.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
define a tournament structure of an electronic sports tournament, the tournament structure comprising a plurality of teams performing the electronic sports tournament on a computer network, each of the plurality of teams comprising one or more players using a computer connected to the computer network;
generate a module for each of a plurality of distinct parts of the tournament structure;
successively simulate each module to generate a model for the electronic sports tournament, the model representing possible actions and outcomes by the teams performing each of the plurality of distinct parts of the tournament structure;
model team behavior of each of the plurality of teams based on the model; and
generate odds of the possible actions and outcomes of the electronic sports tournament based on the successive simulation of each module.

2. The computer program product in accordance with claim 1, wherein the operations further comprise transmitting the odds to a client computer.

3. The computer program product in accordance with claim 2, wherein the transmitting is in response to a user request from the client computer.

4. A system comprising:
one or more client computers having a streaming media module configured to stream video of an electronic sports tournament, and a betting extension that is synchronized with the streaming media module and configured to enable bets by a user of the client computer on the electronic sports tournament; and
a betting platform having an odds modeling engine, the betting platform being configured to:
define a tournament structure of the electronic sports tournament, the tournament structure comprising a plurality of teams performing the electronic sports tournament on a computer network, each of the plurality of teams comprising one or more players using a computer connected to the computer network;
generate a module for each of a plurality of distinct parts of the tournament structure;
successively simulate each module to generate a model for the electronic sports tournament, the model representing possible actions and outcomes by the teams performing each of the plurality of distinct parts of the tournament structure;
model team behavior of each of the plurality of teams based on the model; and
generate, by the odds modeling engine, odds of the possible actions and outcomes of the electronic sports tournament based on the successive simulation of each module.

5. The system in accordance with claim 4, wherein the betting platform is further configured to transmit the odds to one or more of the client computers.

6. The system in accordance with claim 5, wherein the transmitting is in response to a user request from the client computer.

7. The system in accordance with claim 5, wherein the betting extension of each of the one or more client computers is configured to display the odds in a graphical user interface.

8. A computer-implemented method comprising:
defining a tournament structure of an electronic sports tournament, the tournament structure comprising a plurality of teams performing the electronic sports tournament on a computer network, each of the plurality of teams comprising one or more players using a computer connected to the computer network;
generating a module for each of a plurality of distinct parts of the tournament structure;
successively simulating each module to generate a model for the electronic sports tournament, the model representing possible actions and outcomes by the teams performing each of the plurality of distinct parts of the tournament structure;
modeling team behavior of each of the plurality of teams based on the model; and
generating odds of the possible actions and outcomes of the electronic sports tournament based on the successive simulation of each module.

9. The method in accordance with claim 8, further comprising transmitting the odds to one or more of the client computers.

10. The method in accordance with claim 9, wherein the transmitting is in response to a user request from the client computer.
